(19) United States
(12) Patent Application Publication
(10) Pub. No.: US 2025/0257299 A1
(43) Pub. Date: Aug. 14, 2025

(54) METHOD AND SYSTEM FOR REDUCING WATER CONSUMPTION IN A MEMBRANE DEALCOHOLIZATION PROCESS

(71) Applicant: GEA LIQUID TECHNOLOGIES A/S, Skanderborg (DK)

(72) Inventor: Ralf Scheibner, Ettlingen (DE)

(73) Assignee: GEA Liquid Technologies A/S, Skanderborg (DK)

(21) Appl. No.: 18/856,361

(22) PCT Filed: Apr. 4, 2023
(86) PCT No.: PCT/EP2023/058850

§ 371 Date: Oct. 11, 2024

(30) Foreign Application Priority Data
Apr. 13, 2022 (EP) 22168160.4

(51) Int. Cl. C12H 3/04; B01D 61/02; B01D 61/08; B01D 61/12

(52) U.S. Cl. CPC C12H 3/04; B01D 61/026; B01D 61/08; B01D 61/12; B01D 2311/06; B01D 2311/08; B01D 2313/501; B01D 2315/14; B01D 2317/025; B01D 2317/027

(57) ABSTRACT

The present invention relates to a method and system for reducing water consumption in a membrane dealcoholization process. The system comprises a dealcoholization section and a polishing section, where the polishing section comprises one or more membrane polishing units with recirculation of streams.

### TECHNICAL FIELD

The present invention relates to a method and system for reducing water consumption in a membrane dealcoholization process. The system comprises a membrane dealcoholization section and a membrane polishing section, where the membrane polishing section comprises at least two units with reverse osmosis steps with recirculation of streams.

### BACKGROUND ART

Membrane dealcoholization of beverages is a widely known process, and the demand for alcohol reduced or alcohol-free beverages has increased during the last years. An often-used technology for removing alcohol from beverages is reverse osmosis. Reverse Osmosis represents state-of-the-art technology in liquid or water treatment. Reverse osmosis has earned its name as the most convenient and thorough method to filter water from unwanted constituents. It is used by most water bottling plants, and by many industries that require high quality water in manufacturing. Osmosis is the movement of a solvent through a semipermeable membrane (as of a living cell) into a solution of higher solute concentration that tends to equalize the concentrations of solute on the two sides of the membrane. In reverse osmosis this movement is counteracted by the application of a pressure. Dealcoholization using reverse osmosis is known to consume large amounts of water, also the waste product of the dealcoholization process, diluted alcohol, may be a valuable product for use in other applications. Therefore, many processes have been developed which in various ways try to recover alcohol from the discharged water and to recover water that has been used to remove alcohol from the beverage.

Since the efficiency of reverse osmosis is a process that depends on the solute concentration in the various fractions, it is challenging to find ways of obtaining both an efficient dealcoholization process while recovering as much alcohol as possible and being able to recover water or reduce the use of external water in an efficient manner, particularly time and energy efficient.

In WO 2019/178422 a number of solutions are described for recovering high concentration ethanol from the permeate water originating from a membrane dealcoholization process. The alcohol is obtained in high concentration using high pressure reverse osmosis to provide a retentate fraction, which can be further distilled to further increase the concentration of ethanol, as the alcohol product and a water permeate fraction.

In some embodiments the process is combined with a dealcoholization process where ethanol is removed from a beverage in two reverse osmosis steps followed by a high-pressure reverse osmosis step where ethanol in the permeate stream from the dealcoholization step is concentrated and water is recirculated to the dealcoholization process either from the high-pressure reverse osmosis process or from the dealcoholization process itself as part of the water used for the dealcoholization process.

However, it remains a challenge to provide further or improved processes for saving water in the membrane dealcoholization process, further or improved processes that do not compromise production time and quality of the products significantly. Moreover, there is always a need for processes that provide the same or improved quality of products while being more energy efficient or allow for reduced use of resources, such as water.

Therefore, it is an object of the present invention to solve one or more of the problems described above.

### SUMMARY OF THE INVENTION

One or more of these problems are solved in a first aspect by the pro-vision of a membrane dealcoholization and water reduction system said system comprising a dealcoholization section and a polishing section; in which the dealcoholization section comprises at least one membrane dealcoholization unit having a retentate and a permeate side, said membrane dealcoholization unit having a feed inlet positioned at the retentate side of the membrane deal-coholization unit, a retentate outlet a permeate outlet and a water inlet positioned at the retentate side of the membrane dealcoholization unit;
wherein the polishing section comprises at least two membrane polishing units, each having a retentate and a permeate side, in which a first membrane polishing unit has an inlet positioned at the retentate side of the unit, a retentate outlet and a permeate outlet, and in which a second membrane polishing unit has an inlet positioned at the retentate side of the unit, a retentate outlet and a permeate outlet; and
wherein the permeate outlet of the membrane dealcoholization unit is connected to the inlet of the first membrane polishing unit, the permeate outlet of the first membrane polishing unit is connected to the inlet of the second membrane polishing unit, and wherein the retentate outlet of the second membrane polishing unit is connected to the inlet of the first membrane polishing unit, and the permeate outlet of the second membrane polishing unit is connected to the water inlet of the membrane dealcoholization unit.

The presence of at least two membrane polishing units interconnected according to the invention has surprisingly proven to allow generation of clean water in large enough volumes within an acceptable time frame to render a feasible process. Thus, the time efficiency of the solution according to the invention is acceptable or comparable to solutions using only external water without compromising the output, i.e. desired dealcoholization of a solution such as a beverage and the concurrent alcohol recovery. In comparison a solution with one polishing unit under same conditions would take longer to achieve a similar result, as is shown in the appended figures.

In a particular embodiment at least one of the membrane polishing units comprises one or more polishing stages.

Each stage has a retentate side and a permeate side. The inlets of all stages are positioned at the retentate side of the unit. And each stage has a retentate outlet and a permeate outlet. The polishing stages are connected such that the retentate outlet of the first and subsequent stage is connected to the inlet of the second, third stages and so forth. The permeate outlets are all taken either separately or mixed and are connected to the inlet of the second polishing unit.

Including two or more stages of the first membrane polishing units can further optimize the output in terms of water savings with similar operating and installation costs.

In preferred embodiments the first polishing unit comprises two or more polishing stages, preferably 2 or 3 and more preferred 2.

In another particular embodiment the first and/or second polishing units comprise two polishing stages.

It is preferred that the at least two membrane polishing units are reverse osmosis units.

According to embodiments of the invention the at least two membrane polishing units have a semipermeable membrane configured to allow water to pass and wherein the units are configured to allow for an operating pressure in the range of 15 to 80 bar, preferably 30 to 60 bar, more preferred, 40 to 55 bar and wherein the units further have a temperature control means allowing for adjusting to a temperature of −5 to 15° C., preferably −2 to 10° C., more preferred −1 to 8° C.

In further embodiments the membrane dealcoholization unit is a reverse osmosis unit having a semipermeable membrane configured to allow water and alcohol to pass, and optionally wherein the unit is configured to allow an operating pressure in the range of 10 to 55 bar, preferably 12 to 45 bar, more preferred 15 to 36 bar, and wherein the units further have a temperature control means allowing for adjusting to a temperature at or below 25° C., preferably 10 to 20° C.

In a preferred embodiment the permeate outlet of the second membrane polishing unit is connected to the water inlet of the membrane dealcoholization unit directly and/or via an intermediate buffer tank. Such configuration allows for a flexible operation of the system. During the first phase of the process, the amount of permeate water is limited due to the high concentration of solutes whereas during the later operation phase of the system enough permeate water is generated for the dealcoholization, such that the amount of external water added is minimized. The presence of the buffer tank thus allows for both a flexible operation but also further reduction of external water supply, particularly in the early phases of the process where the polishing process has not yet yielded a large amount of polished permeate. This is due to the fact that the configuration allows for collection of polished permeate from an optional preconcentration phase for use in the initial diafiltration phase of the dealcoholization process.

In another aspect, the invention relates to a polishing section for use in a membrane dealcoholization and water reduction process, said polishing section comprises at least two membrane polishing units, where a first membrane polishing unit has an inlet positioned at the retentate side of the unit, a retentate outlet and a permeate outlet, and where a second membrane polishing unit has an inlet positioned at the retentate side of the unit, a retentate outlet and a permeate outlet;
wherein the inlet of the first membrane polishing unit is configured to be connected to a permeate outlet of a membrane dealcoholization unit, and
wherein the permeate outlet of the first membrane polishing unit is connected to the inlet of the second membrane polishing unit, and wherein the retentate outlet of the second membrane polishing unit is connected to the inlet of the first membrane polishing unit, and the permeate outlet of the second membrane polishing unit is configured to be connected to a water inlet of a membrane dealcoholization unit.

Thus, the membrane polishing unit may be retrofitted to existing dealcoholization plants in a simple manner thereby improving on water consumption without significantly compromising the time spent, and at the same time providing a further valuable by-product in the form of concentrated alcohol. Details and variations described for the polishing section in relation to the combined system equally apply to the polishing section when used as a retrofit section.

In some embodiments one or both of the first and second polishing units comprise one or more polishing stages, such as 2 or 3.

In addition to a system the invention also provides a method for reducing water consumption in a membrane dealcoholization process, said method comprising the steps of
i) feeding a solution, such as a beverage product, comprising alcohol to a membrane dealcoholization unit to provide an alcohol reduced solution and an alcohol containing permeate;
ii) feeding the alcohol containing permeate obtained in step i) to the retentate side of a first membrane polishing unit to provide an alcohol enriched retentate and an alcohol depleted permeate;
iii) feeding the alcohol depleted permeate to the retentate side of a second membrane polishing unit, to provide a second alcohol enriched retentate and a permeate substantially comprising or essentially consisting of water;
wherein the second alcohol enriched retentate or a fraction of the second alcohol enriched retentate is fed to the retentate side of the first membrane polishing unit of step ii), optionally pre-mixed with the alcohol enriched permeate, or is discharged; and the permeate substantially comprising or essentially consisting of water is fed to the retentate side of the membrane dealcoholization unit of step i), optionally pre-mixed with a supply of external water.

Large water consumption is a big challenge in the alcohol-free beverage industry and being able to save as little as 10% may be an attractive business case. According to the invention, and as can be seen in the examples, the water savings are as high as 30-85% and even from 50% and up to 100%. This is obtained with similar or lower energy consumption and with an acceptable production time compared to the prior art method while the products obtained are same quality in terms of alcohol content. It was found that in preferred embodiments, the overall process was most feasible when at least two membrane polishing units were present in order to be able to run the process for a sufficiently short time while obtaining the very large water savings. Thus, compared to using one membrane polishing unit the benefit of using two was found to be significant and non-linear.

In a particular embodiment the first polishing unit comprises one or more polishing stages and the alcohol enriched retentate from a polishing stage is fed to the retentate side of a subsequent polishing stage to provide a subsequent stage alcohol enriched retentate and a plurality of stages of permeates constitute the alcohol depleted permeate.

In preferred embodiments the first polishing unit comprises 2 to 3 polishing stages, such as 2.

In a further embodiment the second polishing unit comprises one or more polishing stages and the alcohol enriched retentate from a polishing stage is fed to the retentate side of a subsequent polishing stage to provide a subsequent stage alcohol enriched retentate and a plurality of subsequent stages of permeates constitute the permeate substantially comprising or essentially consisting of water. It is preferred that the second polishing unit comprises 2 to 3 polishing stages, such as 2.

In a further embodiment the first and second polishing unit(s) comprise 2 to 3 polishing stages.

It is preferred that the membrane dealcoholization unit and the first and second (or more) membrane polishing units are a reverse osmosis unit as these technologies have proven efficient in filtering or retaining alcohol from solutions, in particular ethanol from beverages without substantial removal of other solutes.

In preferred embodiments the permeate substantially comprising or essentially consisting of water is fed to a buffer tank and the permeate substantially comprising or essentially consisting of water is fed from the buffer tank to the retentate side of the membrane dealcoholization unit of step i). This intermediate buffer tank is particularly useful in batch processes where the amount of water in the permeate flow varies over time. Thus, in a batch process, the amount of permeate water generated in the starting phase is relatively low. Towards the end of the dealcoholization process, the polished permeate will substitute a larger part of the demand for external water.

In further preferred embodiments the solution fed to the dealcoholizing unit, such as a beverage product, comprising alcohol, in step i) is subjected to a preconcentration step, and wherein the preconcentration water (pcw) generated, is fed to the buffer tank. Collecting the preconcentration permeate in the buffer tank was found to be an important source of water savings during the initial phase of the diafiltration part of the dealcoholization process. Thus, in addition to providing flexibility, the holding tank may also serve as a means for saving more water in the overall process. The preconcentration water may be fed to the buffer tank either through the permeate flow path through the at least two polishing units or via a separate flow. It preferably follows the permeate flow path.

In a preferred process the beverage product is fed at a temperature at or below 25° C. Temperature influences the efficiency of the filtration and it is desired to minimize the energy spent in cooling the liquids, it is therefore a balance. Further, it is preferred that the alcohol enriched permeate obtained in step i) is cooled to a temperature in the range of −5 to 15° C. to provide a cooled alcohol enriched permeate which is fed to the first membrane polishing unit in step ii).

In presently preferred embodiments the alcohol reduced solution obtained in step i) is recovered and sold and/or the alcohol enriched retentate obtained in step ii) is used as alcohol base in an alcoholized solution. More preferred both the alcohol reduced solution and the alcohol enriched retentate are or can be incorporated into commercial products.

According to preferred embodiments the solution is a beverage wherein the alcohol content of the dealcoholized beverage is 0.5% abv or below, preferably <0.5% abv, more preferably <0.05% abv. In such embodiments the beverage can be wine, beer, cider other alcoholic beverages, in preferred embodiments with such low abv the beverage is beer or cider.

It is further contemplated that the second alcohol enriched retentate or a fraction of the second alcohol enriched retentate is fed to the retentate side of the first membrane polishing unit, or, when the first polishing unit comprises two stages, to the retentate side of any of the polishing stages of the first polishing unit of step ii) during operation, optionally pre-mixed with the alcohol enriched permeate. This will further increase the amount of clean water for recirculation and collection of alcohol in the water. In this embodiment however, the second alcohol enriched retentate fraction may be discharged from the method and used for other purposes during start-up and/or at the end of an operation of the method.

According to presently preferred embodiments the mode of operation is batch. Batch operation is typically used when working with beverages and also batch operation is a mode of operation that appears to benefit the most from the flexible set up in terms of water saving.

In further embodiments of the invention where the operation is batch mode the permeate comprising or essentially consisting of water is fed to the top section of the tank and the permeate comprising or essentially consisting of water which is fed to the membrane dealcoholization unit is taken from the lower section of the buffer tank. It is preferred that the buffer tank is configured to allow the feed to layer such that there is minimal mixing whereby the holding time in the buffer tank is substantially the same for any portion of the feed throughout the batch process. As the early stages of the permeate water has the highest alcohol content having a first in first out construction will speed up and improve efficiency of the dealcoholization process.

In a presently preferred embodiment, the system and method consist of two membrane polishing units. This construction has proven to allow for both time and energy efficient generation of a large amount of clean water that may be used for recirculation. In a further presently preferred embodiment, the system and method consist of two membrane polishing units and the first and/or second polishing units comprise 2 or 3 polishing stages, preferably 2. This construction has proven to allow for both time and energy efficient generation of a very large amount of clean water that may be used for recirculation.

According to the invention a dealcoholization and water reduction system is further provided, said system comprising a membrane dealcoholization section and a polishing section in which the dealcoholization section comprises at least one membrane dealcoholization unit having a retentate and a permeate side, said membrane dealcoholization unit having a feed inlet positioned at the retentate side of the membrane dealcoholization unit, a retentate outlet, a permeate outlet and a water inlet positioned at the retentate side of the membrane dealcoholization unit;
wherein the polishing section comprises at least one membrane polishing unit having a retentate and a permeate side, in which the at least one membrane polishing unit has an inlet positioned at the retentate side of the polishing unit, a retentate outlet and a permeate outlet,
wherein the permeate outlet of the membrane dealcoholization unit is connected to the inlet of the membrane polishing unit the permeate outlet of the first membrane polishing unit is connected to the water inlet of the membrane dealcoholization unit, optionally through an intermediate buffer tank.

In preferred embodiments the polishing unit comprises one or more polishing stages, preferably 2 to 3. In further preferred embodiments the permeate outlet of the membrane polishing unit is connected to the water inlet of the membrane dealcoholization unit directly and/or via an intermediate buffer tank.

Having one polishing unit provides water saving although at a higher energy consumption than with two polishing units as is shown in the examples below however, introducing two or more polishing stages in the polishing unit will improve the balance. Also introducing an intermediate buffer tank further provides for water savings.

### BRIEF DESCRIPTION OF DRAWINGS

In the following description embodiments of the invention will be described with reference to the schematic drawings, in which:

FIG. 1 shows an overview of an embodiment of a system according to the invention.

FIG. 2 shows an overview of another embodiment of a system according to the invention.

FIG. 3 shows an overview of an embodiment of a system according to the invention in its most general sense.

FIG. 4 shows an overview of an embodiment of a system according to the invention in which a first polishing unit comprises two polishing stages.

FIG. 5 shows an overview of an embodiment of a system according to the invention in which a first polishing unit comprises three polishing stages.

FIG. 6 shows an overview of an embodiment of a system according to the invention in which a first and second polishing unit comprise two polishing stages.

FIGS. 7a, 7b and 7c show in FIG. 7a normalized processing time (t) of a dealcoholization process without recirculation of process water, FIG. 7b shows the same with the introduction of recirculation of polished permeate using two polishing units, and FIG. 7c shows the same with the introduction of recirculation of polished permeate using one polishing unit. In all graphs the upper line is the amount of alcohol in the beverage, shown with triangles, and the lower line is the amount of alcohol in the alcohol enriched permeate over time (i.e., corresponding to p2), shown with circles. The x axis shows normalized time units, t, and the y axis shows the normalized alcohol content, AC.

FIGS. 8a, 8b, 8c and 8d show the use of external water and recirculated permeate flow with and without a buffer tank. In FIG. 8a, the supply of external water is shown over time. In figures, 8b, 8c and 8d, the upper line is the recycled polished permeate, shown as triangles, and the lower line is the external water supply, shown with circles.

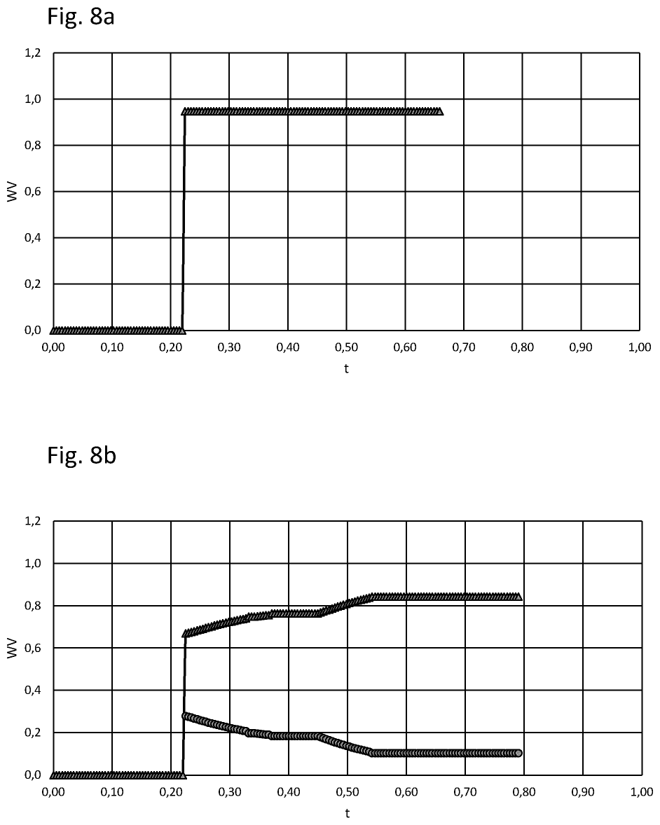

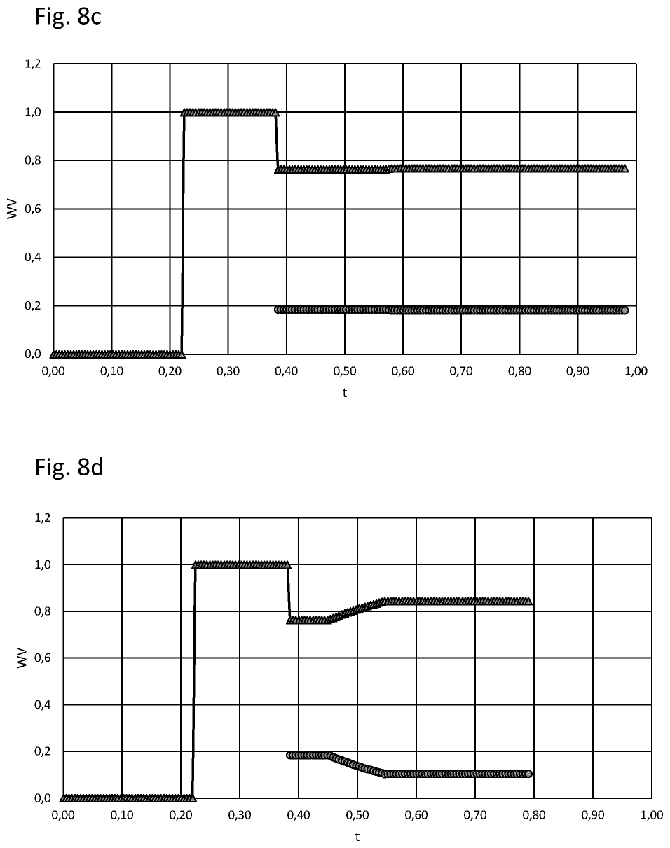

The sum of the upper and lower lines corresponds to the supply of external water in FIG. 8a. The x axis' show normalized time units, t, and the y axis' show the normalized water volume supplied, WV.

### DETAILED DESCRIPTION

According to the invention both the dealcoholization and membrane polishing units are membrane units having semipermeable membranes.

The semipermeable membranes according to the invention are of a nature that allows water or water and alcohol to pass through and, as such, essential ingredients that comprise for example aroma, color and other components that cause turbidity are predominantly retained and not separated from the retentate unlike some prior art solutions. In particular the dealcoholization membrane allows alcohol and water to pass such that the flavors and aromas of the dealcoholized beverage are retained at this stage. And the polishing unit membranes allow water to pass and retain alcohol, such that alcohol is concentrated at the retentate side.

Suitable semipermeable membranes for use in the polishing units according to the invention are reverse osmosis or nanofiltration membranes these are typically standard thin-film polymer membranes, such as Filmtec™ membranes obtainable from DOW, Hydranautics membranes of the ESP series, such as ESPA4-DL, Turboclean RO membranes from Trisep, such as RO ACM2-46, Fluid Systems® from Koch Separation Solutions, such as TFC SR200/400/34 or RO membranes from LG Chem, LG BW 440 UES.

Suitable semipermeable membranes for use in the dealcoholization units are reverse osmosis or nanofiltration membranes usable according to the invention and are standard thin-film polymer membranes, such as Filmtec™ membranes of the TW type obtainable from DOW, Hydranautics membranes of the CP or SanRO series, RO membranes from LG Chem, GEA AromaPlus or TML membranes from Toray. Such membranes have a higher chemical resistance than cellulose acetate membranes originally used for membrane dealcoholization.

The typical permeation of membranes usable according to the invention have a salt rejection of minimum 80% when using standard test conditions such as testing at 32,000 ppm NaCl, 5 ppm Boron, 800 psi (5.5 MPa), 25° C., pH 8 and 8% recovery.

According to the invention a solution is preferably an alcoholized beverage, and consequently in these embodiments the alcohol is ethanol. An alcoholized beverage may be selected from but not limited to beer, wine, liqueur, sparkling wine, cider, spirits, like gin and whisky, fermented drinks like kvass and kombucha. In preferred embodiments the beverage is beer, wine or cider as these beverages are produced at the highest volumes.

According to the invention external water is suitably tap water, in some embodiments it is preferred that it is deoxygenated water, such as deoxygenated brew water. The production and use of deoxygenated water is common knowledge for the skilled person. The oxygen level depends on the specific needs of the products and business requirements and providing this is within the common knowledge. The raw water for deoxygenation is in some embodiments softened or preferably demineralized water.

According to the invention the terms retentate and concentrate should be understood as having the same meaning.

As is known in the art membrane dealcoholization processes typically first include a preconcentration phase followed by the diafiltration process where the permeate fractions comprise water and alcohol and trace amounts of other components of the solution.

The system and method of the invention may be operated both as batch and a continuous process. Preferred is a batch process.

According to embodiments of the invention reverse osmosis in the dealcoholization section operates at filtration temperatures of approximately 0 to 50° C., presenting no thermal stress to the solution or beverage to be treated in order to preserve in particular flavor and aroma. Preferably the temperature is at or below 25° C., preferably 10 to 20° C. The pressure in the dealcoholization process has an operating pressure in the range of 10 to 55, preferably 12 to 45 bar, more preferred 15 to 36 bar. It is preferred that the alcohol is ethanol even though the invention should not be limited thereto.

According to embodiments of the invention reverse osmosis in the polishing section operates at filtration temperatures of approximately −5 to 15° C., preferably −2 to 10° C., more preferred −1 to 8° C. The pressure in the polishing section has an operating pressure in the range of 15 to 80 bar, preferably 30 to 60 bar, more preferred, 35 to 55 bar.

If an exemplary batch process has an initial beverage volume of 1000 hL. For the dealcoholization process, the ratio of dealcoholization water to feed is typically 1.5:1 to 4:1 depending on whether the desired alcohol content in the dealcoholized beverage or solution is 0.5% abv or 0.05% abv. abv refers to alcohol by volume.

Hence, with water savings of up to 85 to 100% as exemplified, corresponds to 1,700 to 4,000 hL of water savings for processing 1000 hL of solution.

According to embodiments the invention the membrane dealcoholization starts with a preconcentration step without any diafiltration. Typically, the feed is concentrated from 2 to less than 5 times, such as 3 to 4 times.

The permeate from the preconcentration step may be fed to the buffer tank, when present, and be used for the initial diafiltration of the feed thereby saving a substantial amount of water. The permeate may be fed to the buffer tank either through the permeate flow path through the at least two polishing units or via a separate flow. It preferably follows the permeate polishing flow path.

The process according to the invention as well as a membrane dealcoholization process without a membrane polishing section has a duration of around 13 to 15 hours. Introducing full recirculation of permeate only slightly increased the processing time to around 16 hours. Hence, the savings in water and energy by far exceeds the extra time needed for the process. In addition, when including a buffer tank, the water savings are even more increased since the preconcentration permeate can be used in the initial diafiltration phase. Compared to processes with only one membrane polishing unit it was found that the processing time using two or more membrane polishing units is significantly reduced and more comparable to using only external water—hence resulting also in energy savings due to a shorter processing time.

Introducing one or more polishing stages in one or more of the polishing units further optimizes the alcohol recovery without adding additional operating expenses to the process.

It is to be understood that when a polishing unit has more than one stage, the term “inlet of the polishing unit” means the inlet of the first stage of the polishing unit.

Unless specified that a connection, feed, inlet or outlet is to a specific stage of a polishing unit it is to be understood that it is the inlet and outlet of the first and last stages respectively.

Throughout the description and claims any reference to a dealcoholization and/or polishing unit should be understood to be a membrane-based unit.

Embodiments of the system and method according to the invention will now be described with reference to the figures. The solution to be treated is described as a beverage, but the invention should not be limited to a solution used for consumption.

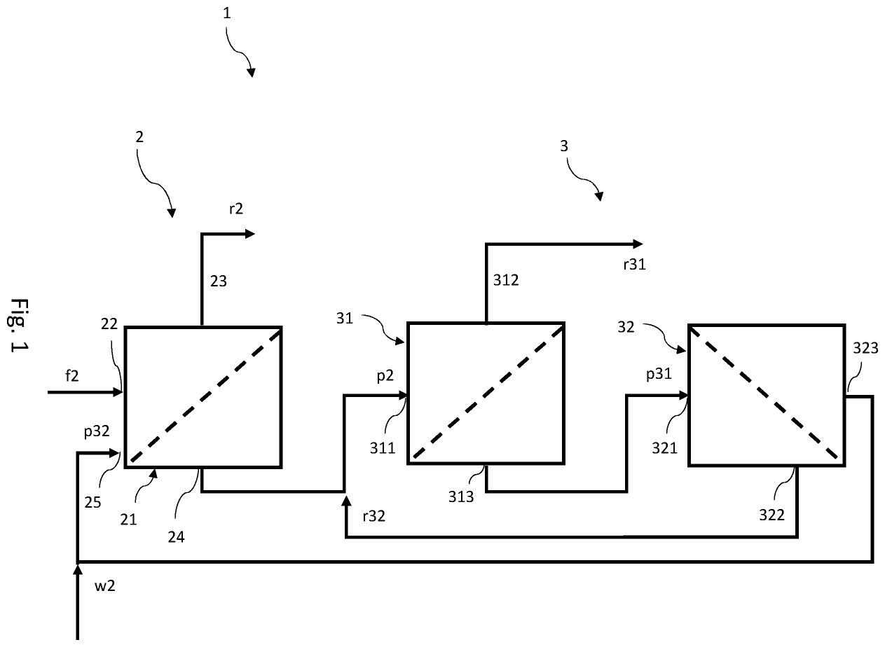

In FIG. 1 a membrane dealcoholization and water reduction system 1 is shown, said system comprising a dealcoholization section 2, and a polishing section 3; the dealcoholization section 2 comprises at least one membrane dealcoholization unit 21, having a retentate and a permeate side, said membrane dealcoholization unit having a feed inlet 22, positioned at the retentate side of the membrane dealcoholization unit, a retentate outlet 23, a permeate outlet 24, and a water inlet 25, positioned at the retentate side of the membrane dealcoholization unit.

The membrane dealcoholization unit 21 is preferably a reverse osmosis unit having a semipermeable membrane allowing water and alcohol to pass, while retaining other solutes of the beverage thus providing a dealcoholized beverage having a desired taste and mouthfeel. The starting abv of the feed can be up to 20% to 40% abv, typically it is 3% abv to 15% abv, most often 3.5 to 8% abv, but it may be higher or lower. It is contemplated that the feed, f2, may be fed from a buffer tank (not shown).

The target abv of the dealcoholized beverage is typically, <0.5% abv, preferably <0.05% abv but higher targets are contemplated.

The target abv can be up to 2.5% abv or higher, such as 4% abv or higher, preferably 5 to 8% abv.

For example, for beer and cider it is preferred that the target abv is <0.5% abv, preferably <0.05% abv, but it can be 2.5% abv or higher.

Target abv in the range of 4 to 8% abv is preferred for beverages other than cider and beer.

This may be achieved by diluting the alcohol reduced solution leaving the dealcoholizing unit to the desired level.

The at least one membrane dealcoholization unit 21 is configured to allow for an operating pressure in the range of 10 to 55 bar, preferably 12 to 45 bar, more preferred 15 to 36 bar, and further having a temperature control means allowing for a temperature at or below 25° C., preferably 10 to 20° C. Suitable units are GEA AromaPlus Membrane dealcoholization unit available from GEA. The treatment in the membrane dealcoholization unit 21 provides an alcohol reduced solution, r2, and an alcohol containing permeate, p2. The alcohol reduced solution, r2, will typically have an alcohol content below 0.5% abv, preferably below 0.05% abv unless a higher target abv is desired. The major part of the alcohol of the feed, f2, leaves the membrane dealcoholization unit 21 in the alcohol containing permeate, p2. The relative alcohol content in the total merged permeate is low due to the high volume of water used, typically below 1.5% abv but can be higher depending on the initial beverage abv and the target of the dealcoholization.

The polishing section 3 comprises at least two membrane polishing units 31 and 32, each having a retentate and a permeate side, in which a first membrane polishing unit 31 has an inlet 311, positioned at the retentate side of the unit, a retentate outlet 312, and a permeate outlet, 313, and in which a second membrane polishing unit 32 has an inlet 321, positioned at the retentate side of the unit, a retentate outlet 322, and a permeate outlet 323. The membrane polishing units, 31 and 32, may be the same type or different, preferable they are of the same type operated under similar conditions. It is however contemplated that they may have different dimensions, also when under same conditions.

The dealcoholization and membrane polishing units are fluidly connected such that the permeate outlet 24 of the membrane dealcoholization unit 21 is connected to the inlet 311 of the first membrane polishing unit 31, the permeate outlet 313 of the first membrane polishing unit 31 is connected to the inlet 321 of the second membrane polishing unit 32, and the retentate outlet 322 of the second membrane polishing unit 32 is connected to the inlet 311 of the first membrane polishing unit 31, and the permeate outlet 323 of the second membrane polishing unit 32 is connected to the water inlet 25 of the membrane dealcoholization unit 21. Thus, the second membrane polishing unit does not communicate with the surroundings but is in full circulation with the first membrane polishing unit 31 and the membrane dealcoholization unit 21.

External water may be supplied in stream w2 either directly to the membrane dealcoholization unit 21 through the water inlet 25 or mixed with the second alcohol depleted permeate p32.

The at least two membrane polishing units, 31 and 32, are in the embodiment shown reverse osmosis units. The semipermeable membrane of two membrane polishing units 31 and 32 are configured to allow water to pass whereas other constituents of the solution, such as trace amounts of aroma and flavor and alcohol, are essentially retained by the membrane. Examples of membranes include but are not limited to Filmtec membranes from Dow or Dupont, such as Filmtec from Dow, Hydranautics membranes of the ESP series, such as ESPA4-DL, Turboclean RO membranes from Trisep, such as RO 8038-ACM2-46, Fluid Systems® from Koch Separation Solutions, such as TFC SR200 8040-SR200-400-34 or RO membranes from LG Chem, such as LG BW 440 UES.

The units are configured to allow for an operating pressure in the range of 15 to 80 bar, preferably 30 to 60 bar, more preferred, 40 to 55 bar and further having a temperature control means allowing for a temperature of −5 to 15° C., preferably −2 to 10° C., more preferred −1 to 8° C.

In the first membrane polishing unit a first concentration of alcohol takes place, and the alcohol enriched retentate, r31, is drawn from the polishing unit 31 and is in preferred embodiments used as is or as an alcohol base for other products, including beverages such as Hard Seltzers, including beverages such as flavored alcoholic beverages (FAB) or neutral malt-based beverages (NMB), or is discharged. The alcohol enriched retentate may have an alcohol content of up to 25% abv. The alcohol enriched retentate may be further concentrated as is illustrated in further embodiments described below. The alcohol depleted permeate, p31, is further depleted from alcohol in the second polishing unit, 32.

In terms of flow, in an example, the flow of the alcohol containing permeate, p2 is considered 100%. Relative hereto, the flowrate of the alcohol depleted permeate, p31, of the first membrane polishing unit comprises at least 10% of the flow of the alcohol containing permeate, p2, for example 10 to 85 to 98%, and the alcohol enriched retentate, r31, comprises at least 2% of the flow of the alcohol containing permeate, p2, for example 2 to 65 to 90%. The alcohol enriched retentate, r31, can have an alcohol content of up to 25% abv whereas the alcohol depleted permeate, p31, can have an alcohol content of above 0 and up to 12% abv.

In the second polishing unit 32, the alcohol depleted permeate, p31, of the first membrane polishing unit 31 is further depleted from alcohol to provide a second alcohol enriched retentate, r32, and a permeate, p32. The second alcohol enriched retentate, r32, comprises at least 2% of the flowrate of the alcohol containing permeate, p2, for example 2 to 50 or up to 95%, and the flowrate of the second alcohol depleted permeate, p32, of the second membrane polishing unit comprises at least 5% of the flowrate of the alcohol containing permeate, p2, for example 5 to 85 or up to 98%. The second alcohol enriched retentate, r32, can have an alcohol content of up to 15% abv whereas the alcohol depleted permeate, p32, can have an alcohol content of 0 to 10% abv.

The second alcohol enriched retentate, r32, or a fraction thereof can, as in the embodiment shown, be fed to the retentate side of the first membrane polishing unit 31 during operation, it may be fed directly to the membrane polishing unit in a separate feed inlet or be pre-mixed with the alcohol enriched permeate, p2. Thereby further alcohol is captured and the amount of retentate leaving the polishing section is further reduced. During start-up and/or at the end of a batch operation of the method, the fraction of the second alcohol enriched retentate is typically discharged from the method and system and used for other purposes since the amount of alcohol in the alcohol containing permeate, p2, has not been built up.

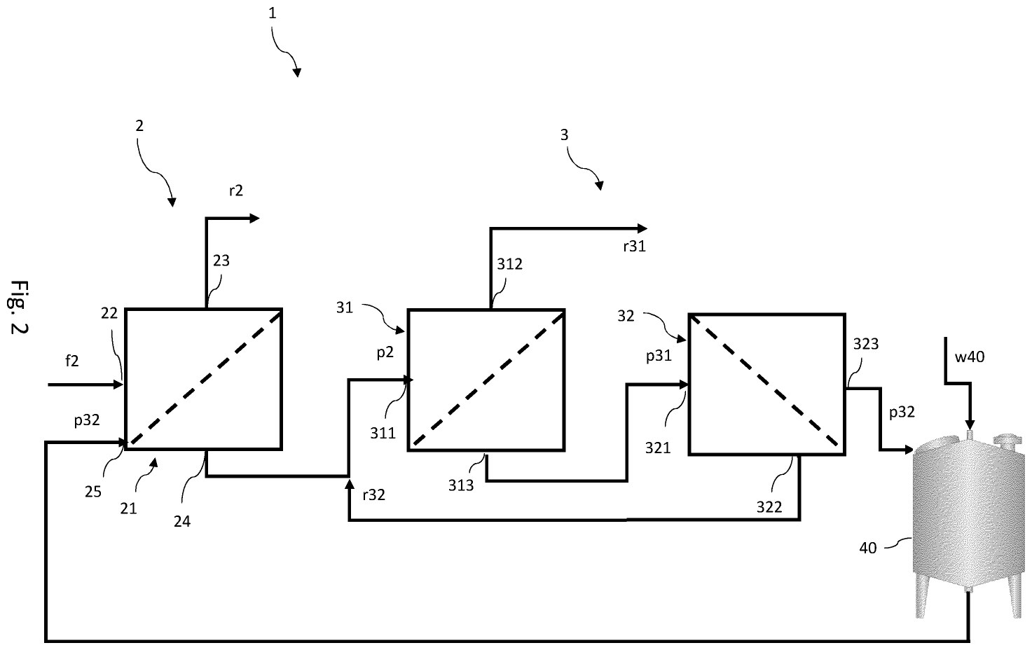

With reference to FIG. 2 a further embodiment is shown in which all units and streams are the same as described for FIG. 1 but where the permeate outlet 323 of the second membrane polishing unit 32 is connected to the water inlet 25 of the membrane dealcoholization unit 21, via an intermediate buffer tank 40. In some embodiments preconcentration permeate from the dealcoholization section, 2, may be directed to the buffer tank 40, and be used as a means for water supply in the initial phase of the diafiltration part of the dealcoholization. The presence of the buffer tank 40 is thus an important source of optimizing the water saving during the process by providing flexibility in the water flows during the stages of the dealcoholization process, in particular for a batch process.

In variations of the embodiment of FIG. 2 it is contemplated that during processing, the flows can be redirected-intermittently-in various ways in order to maintain the required high pressure and sufficient flow throughout the process especially in the beginning and end of a batch and thereby ensuring an efficient diafiltration.

Thus, in one variation of such redirection, it is contemplated that water from the buffer tank is fed to the retentate side 321 of the second polishing unit 32, optionally premixed with the first dealcoholized permeate, p31.

In another variation of such redirection the permeate or a portion of the permeate p32 is circulated back to the retentate side 321 of the second polishing unit 32, optionally premixed with the first dealcoholized permeate, p31. In yet a variation of such redirection a portion of the first dealcoholized permeate, p31, is circulated back to the retentate side 311 of the first polishing unit 31, optionally premixed with the alcohol enriched permeate. In yet a variation, a portion of the first dealcoholized permeate, p31, is circulated back to the retentate side 311, of the first polishing unit 31, water from the buffer tank 40 is fed to the retentate side, 321, of the second polishing unit 32, optionally premixed with the first dealcoholized permeate, p31.

In configurations with three or more polishing units, (33, 34 . . . ), (not shown) the polishing units are connected such that the permeate outlet(s) of polishing unit n is fluidly connected to the inlet of polishing unit n+1 which in the retentate side. The permeate outlet of the last polishing unit is then recirculated and connected to the water inlet of the membrane dealcoholization unit, 21, optionally via an intermediate buffer tank. The retentate outlet of the subsequent membrane polishing units are either recirculated to one of the inlets of one of the previous membrane polishing units (31, 32, etc.), mixed with the alcohol enriched retentate (r31) or is discharged.

Having more than two membrane polishing units will further shorten the total processing time. The alcohol concentration which can be achieved from the first polishing unit will also be higher as the retentate volumes are lower.

The need for external water supply using three or more polishing units may also be reduced but only marginally, since using two polishing units was surprisingly found to be close to the limit of water recovery possible, in particular in embodiments where the first and/or second polishing unit has more than one stage, such as 2 or 3.

Hence in preferred embodiments three or more membrane polishing units are used, when processing time is important.

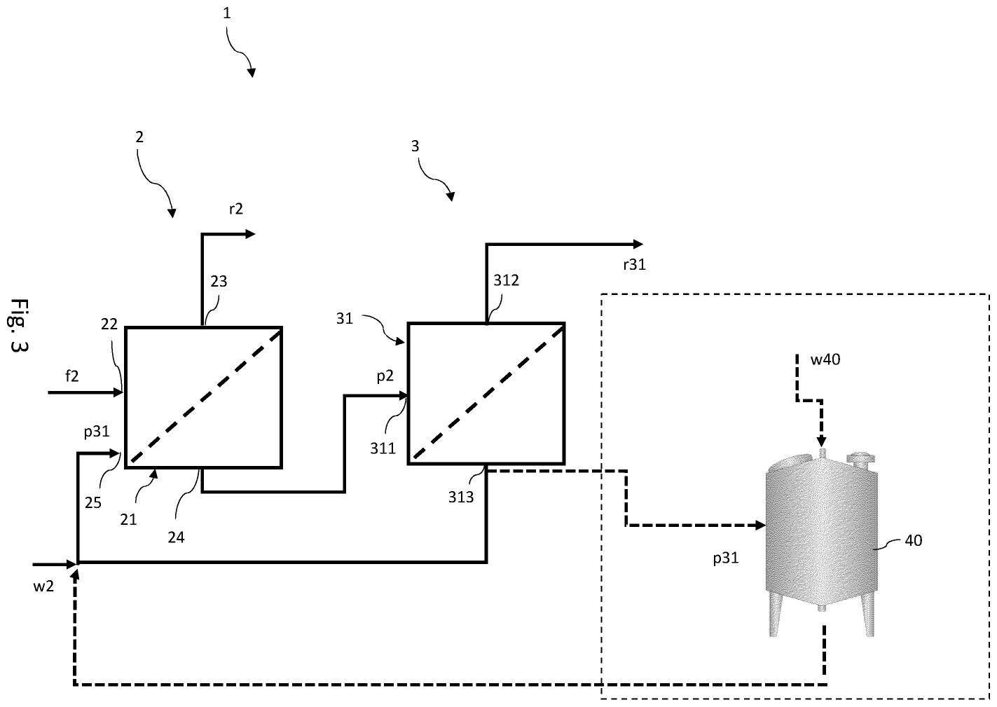

With reference to FIG. 3, the system of the invention will be described in its most general aspect where the invention relates to a dealcoholization and water reduction system 1, said system comprising a membrane dealcoholization section 2, and a polishing section 3; in which the dealcoholization section 2 comprises at least one membrane dealcoholization unit 21, having a retentate and a permeate side, said membrane dealcoholization unit having a feed inlet 22, positioned at the retentate side of the membrane dealcoholization unit, a retentate outlet 23, a permeate outlet 24, and a water inlet 25, positioned at the retentate side of the membrane dealcoholization unit;
wherein the polishing section 3 comprises at least one membrane polishing unit 31, having a retentate and a permeate side, in which the at least one membrane polishing unit 31 has an inlet 311, positioned at the retentate side of the unit, a retentate outlet 312, and a permeate outlet 313,
wherein the permeate outlet 24 of the membrane dealcoholization unit 21 is connected to the inlet 311 of the membrane polishing unit 31, the permeate outlet 313 of the first membrane polishing unit 31 is connected to the water inlet 25 of the membrane dealcoholization unit 21, optionally through an intermediate buffer tank 40. When operating with one membrane polishing unit at certain conditions, the dealcoholization time and recirculation ratio was surprisingly better than the prior art. Such a process with at least one polishing unit, can provide a permeate water stream that can be used to replace external water. The processing time is longer than using only external water or at least two polishing units.

It is contemplated that the at least one polishing unit 31 comprises one, two or more polishing stages (31.1, 31.2 etc.). The polishing stages of the first unit are fluidly connected such that the retentate outlet of a first stage is connected to the inlet of the retentate side of a second polishing stage and so forth. The permeate outlets of each stage may be mixed or used separately as described above.

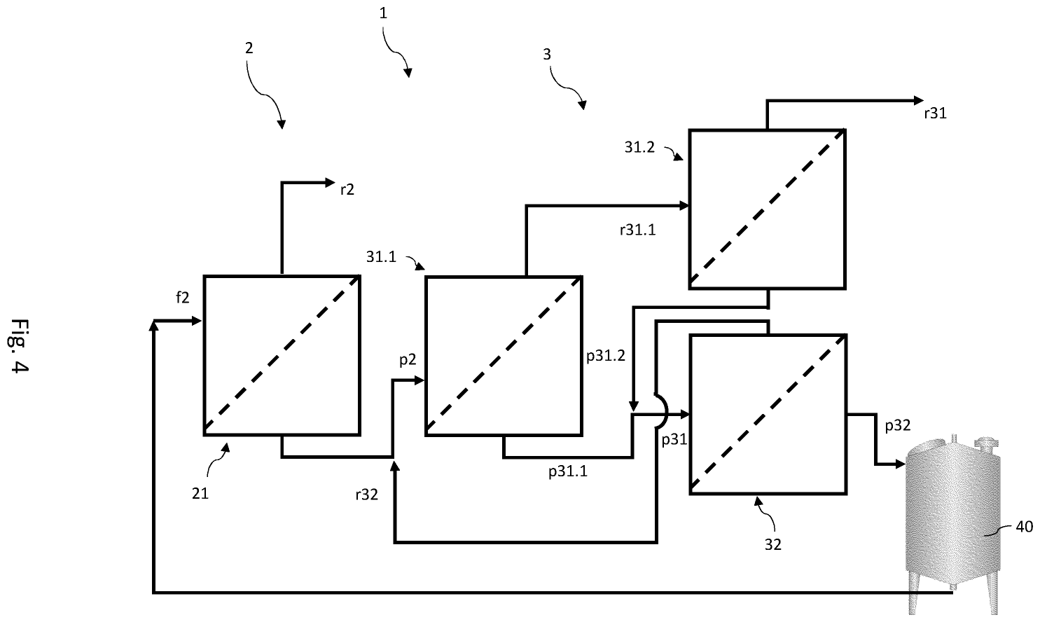

In a further variation of the embodiment shown in FIGS. 1 and 2, the first polishing unit 31 comprises two polishing stages 31.1 and 31.2 as illustrated in FIG. 4. The reference numerals are the same as those used in FIGS. 1 and 2 and only differences relative to the previous embodiments will be described in detail.

In the first polishing stage a first stage retentate r31.1 and a first stage alcohol depleted permeate p31.1 are formed. The first stage retentate, r31.1, of the first polishing stage 31.1 is fed to the inlet of the retentate side of the second polishing stage 31.2 in order to provide the first retentate, r31, and a second stage alcohol depleted permeate, p31.2. The permeates, p31.2 and p31.1, may be mixed or fed separately to the second polishing unit 32 as alcohol depleted permeate, p31.

Referring now to FIG. 5, an embodiment is shown in which the first polishing unit 31 comprises three polishing stages 31.1, 31.2, 31.3. In addition to the embodiment shown in FIG. 4, the second stage retentate, r31.2, is fed to the inlet on retentate side of the third polishing stage 31.3 of the first polishing unit to provide the first retentate, r31, and a third stage alcohol depleted permeate p31.3, the first, second and third stage permeates, p31.1, p31.2 and p31.3 constitute the alcohol depleted permeate p31.

In the embodiments shown in FIGS. 4 and 5 the first polishing unit 31 has two and three polishing stages; however, it is contemplated that the principle is the same for four or more polishing stages comprised in the first polishing unit. Accordingly, the retentate outlet of an upstream polishing stage is fed to the inlet of the retentate side of a downstream polishing stage and so forth. The combined permeates, i.e., alcohol depleted permeates, from each stage are fed to the inlet of the retentate side of the second polishing unit 32. It is contemplated that permeates are fed directly or mixed before being fed to the second polishing unit 32.

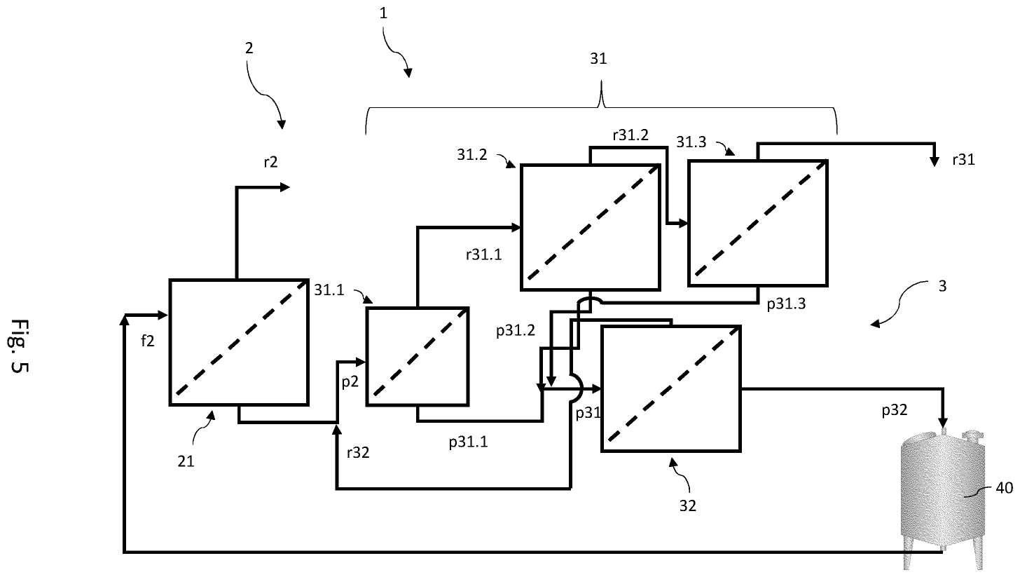

In FIG. 6 a further variation is shown in which both the first and second polishing units have two polishing stages, 31.1, 31.2, and 32.1, 32.2, respectively. Similar to the embodiments shown in FIGS. 4 and 5, the first stage retentate of the first polishing stage 31.1 is fed to the inlet positioned in the retentate side of the second polishing stage 31.2 of the first polishing unit 31 to provide the first retentate, r31 and the second stage alcohol depleted permeate p31.2, first and second stage alcohol depleted permeates, p31.1 and p31.2 constitute the alcohol depleted permeate, p31.

The alcohol depleted permeate p31 is fed to the retentate side of the second polishing unit 32. In the embodiment shown, the first and second stage permeates p31.1 and p31.2 are mixed before entering the second polishing unit 32. It is however contemplated that they can be mixed at any stage or be fed separately to the second polishing unit 32.

In the second polishing unit 32 the first stage retentate r32.1 of the first polishing stage 32.1 is fed to the retentate side of the first polishing unit 32 (the first stage of the first unit) and the first stage permeate p32.1 is connected to the inlet on the retentate side of the second polishing stage 32.2 of the second polishing unit. The second stage second alcohol enriched retentate r32.2 of the second polishing stage 32.2 of the second polishing unit is either fed to the retentate side of the first polishing stage 32.1 of the second polishing unit, mixed with the first stage second alcohol enriched retentate r32.1 or fed to the retentate side of the first stage of the second polishing unit 32.1. The permeate, p32, of the second (or last) stage of the second polishing unit is connected to the retentate inlet of the at least first dealcoholization unit 21, optionally via a buffer tank, 40.

It is contemplated that also the second polishing unit can comprise further polishing stages, preferred is 1 to 3.

In all variations of the embodiments described it is contemplated that any of the effluent product streams may be further concentrated by way of evaporation, distillation, freeze concentration or other methods used in the art for concentrating a liquid. Similarly, it is contemplated that the product streams may be diluted to a desired percentage of solute concentration.

All equipment and piping are standard equipment used in the art and the skilled person will be familiar herewith.

### EXAMPLES

### Example 1

### Duration of Dealcoholization Processes

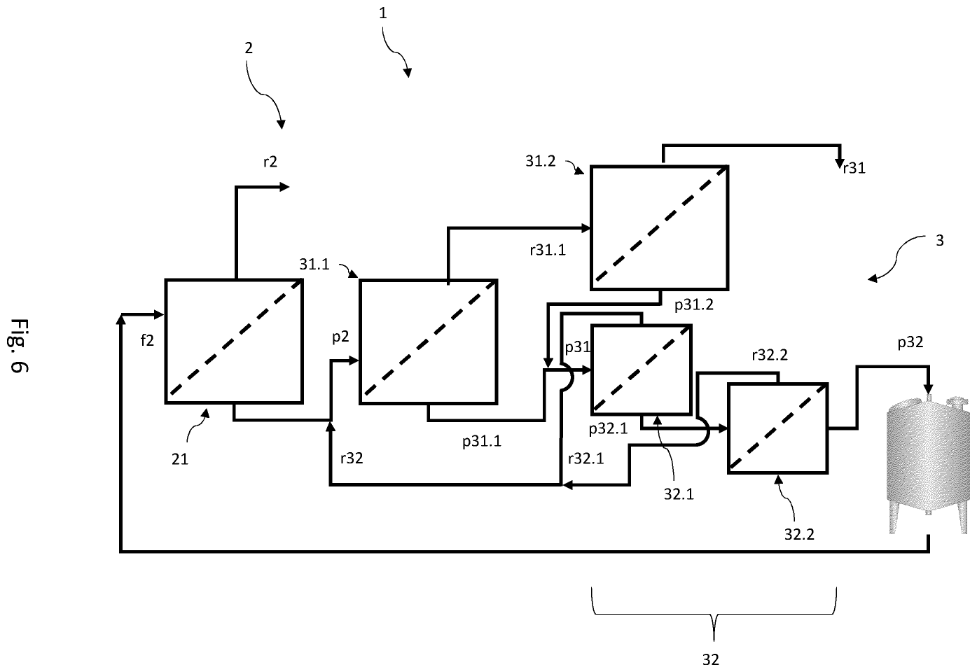

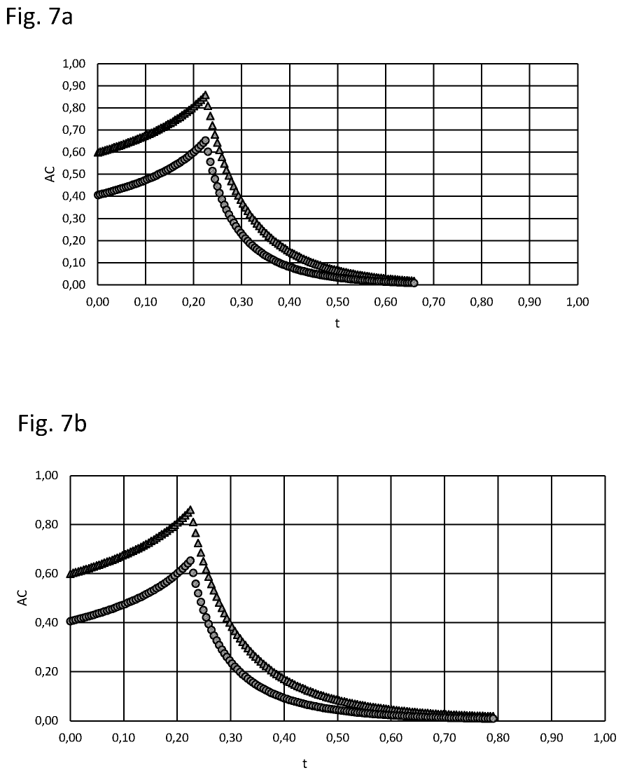

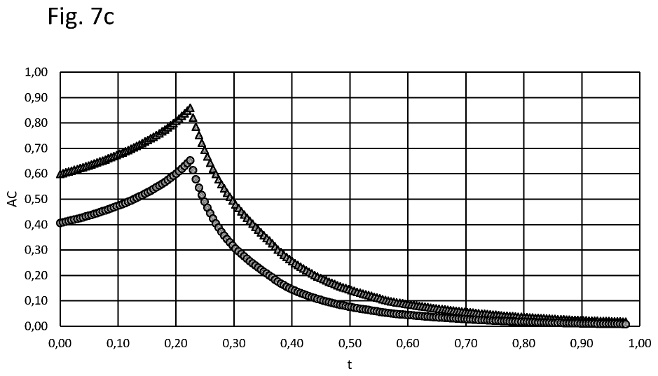

FIG. 7 illustrates a dealcoholization process without reuse of water (7a), with recirculation according to the invention with two membrane polishing units (7b) and with recirculation according using one membrane polishing unit (7c). In all the figures the upper line shows the alcohol content in the beverage to be dealcoholized, whereas the lower line shows the alcohol content in the alcohol enriched permeate (corresponding to p2).

A batch dealcoholization was simulated using a GEA proprietary simulation program. Similar simulations can be made using commercially available software such as Matlab, Chemcad or Aspen. The batch was tested with a typical high density beer product (i.e., initial abv around 7% abv). The initial beer volume was for this example set to 100000 liters (1000 hL). The dealcoholization process was initiated with a preconcentration around 3.5 times before the actual diafiltration started. In the first experiment dealcoholization was performed using pure water for comparison and in the second the process was according to the invention and with two polishing units. As can be seen from the graphs of FIGS. 7a and 7b, the duration of the processes is substantially the same. The process according to the invention is marginally longer. It is however a good tradeoff for being able to recycle water from the process itself. As is known the speed of the filtration is highly dependent on the solute concentration. Hence, it was unexpected that the duration of the processes was almost the same even though the method of the invention recirculates water with traces of solutes. A few solutes originating from the beverage itself and trace amounts of alcohol will inevitably be present in the permeates.

Finally, and to further compare two versus one polishing unit, as shown in FIG. 7c an experiment was made with one polishing unit but same conditions otherwise. Here it can be seen that the duration of the process was over 20% longer when using same conditions.

### Example 2

### Illustration of the Water Usage According to the Invention with and without Using a Buffer Tank

According to embodiments of the invention as illustrated in FIGS. 2 and 3, the effect on the water usage is illustrated below including using a buffer tank which is presently preferred after the polishing unit(s) for intermediate storage of permeate water. The processes were simulated as detailed under example 1 and specifically the preconcentration phase proceeded until the feed had been concentrated 3.5 times.

The supply of water to the process is illustrated in FIGS. 8a, b, c and d, showing embodiments:
8a without a polishing unit and buffer tank;
8b with two polishing units but without a buffer tank;
8c with one polishing unit and a buffer tank; and
8d with two polishing units and a buffer tank.

As mentioned above in FIG. 8a the graph shows the supply of external water. In FIGS. 8b to 8d, the upper lines show the supply of polished permeate in triangles and the lower lines show the supply of external water as circles.

Referring now to FIG. 8a, as can be seen, in the beginning, around ⅓ of the time, of the process, no external water was supplied, this is the preconcentration phase of the dealcoholization process. After the preconcentration phase, external water was fed to the dealcoholization unit in order to provide the dealcoholized beverage. Processing time stopped at around 0.65 time units, and the water volume was around 0.95 per time unit from 0.22 to the end. This figure illustrates prior art.

In FIG. 8b the process is shown with two polishing units and without a buffer tank. The process followed the same path and need for water supply. Hence, it can be seen that also at around time unit 0.22 after the preconcentration phase water from the second polishing unit and external water was fed to the dealcoholization unit. External water volume at around 0.3 in the initial time units, declining to a water volume of around 0.1 at around 0.55 time units. The remaining part up to around 0.95 water volume was recycled polished permeate.

Hence, as can be seen the processing time with two polishing units is a little longer, but the need for external water supply decreases, here from 0.95 volume units to 0.3 to 0.1 volume units. A significant saving in the need for external water.

In FIG. 8c the process is shown with one polishing unit and with a buffer tank. The process followed the same path and need for water supply as above. Hence, it can be seen that also at around time unit 0.22 after the preconcentration phase water was fed to the dealcoholization unit. However, given that the preconcentration water had been collected, the need for external water supply at time unit 0.22 to 0.375 was completely moot. Only at a time unit just before 0.4 was there a need for around 0.2 volume units external water and combined with the 0.75 volume units from the polishing unit, the total need was met.

Hence, as can be seen the processing time with one polishing unit and a buffer tank was around 50% longer than with no polishing units or buffer tank and around 20% longer with two polishing units and a buffer tank, thus resulting in around 25% prolonged processing time comparing one with two polishing units. However, the total need for external water supply decreased compared to the embodiment with no polishing units which is further facilitated by the presence of the buffer tank. Hence, while allowing for a longer processing time the external water saving is significant.

Turning now to FIG. 8d the process is shown with two polishing units and with a buffer tank. The process followed the same path and need for water supply as above. Hence, it can be seen that also at around time unit 0.22 after the preconcentration phase, water was fed to the dealcoholization unit. However, given that the preconcentration water had been collected the need for external water supply at time unit 0.22 to 0.375 was completely moot. Only at a time unit just before 0.4 was there a need for around 0.2 volume units external water which further reduced to around 0.1 volume units at around 0.55 time units and onwards and combined with the 0.75 volume units to 0.85 volume units from the polishing unit the total need was met.

Hence, as can be seen the processing time with two polishing units and a buffer tank was around 20% longer than with no polishing units, however, the total need for external water supply decreased significantly compared to all the embodiments shown.

Hence, it can be seen that the systems and methods of the invention allow for significant water savings. It can also be seen that the lowest demand for external water is in embodiments with at least two polishing units and where there is a buffer tank to which preconcentration water is fed.

Adding further stages to one or both units further reduced need for external water (not shown).

### Example 3

### Illustration of Total Energy Consumption Comparing Variations with One and Two Membrane Polishing Units

TABLE 1
membrane dealcoholization unit with one polishing unit

| | | | |
|---|---|---|---|
| Pump energy | kW | 5.181 | 100% |
| Cooling energy | kW | 10.318 | 100% |
| Deox. Water | hl | 787 | 100% |

TABLE 2
membrane dealcoholization unit with two polishing units

| | | | |
|---|---|---|---|
| Pump energy | kW | 5.091 | 98% |
| Cooling energy | kW | 9.202 | 89% |
| Deox. Water | hl | 470 | 60% |

As can be seen from the tables the cooling energy of having two membrane polishing units decreases compared to the variation with one polishing unit. The saving in energy is mostly assigned to the shorter processing time. Hence, with two or more polishing units the saving in energy will be significant compared to one.

Thus, in addition to a significant water saving embodiments of the present invention also provides a more energy efficient solution.

What is claimed is:

1. A membrane dealcoholization and water reduction system, said system comprising a dealcoholization section and a polishing section; in which the dealcoholization section comprises at least one membrane dealcoholization unit having a retentate side and a permeate side, said at least one membrane dealcoholization unit having a feed inlet positioned at the retentate side of the at least one membrane dealcoholization unit, a retentate outlet, a permeate outlet and a water inlet positioned at the retentate side of the at least one membrane dealcoholization unit;
wherein the polishing section comprises at least two membrane polishing units, each having a retentate side and a permeate side, in which a first membrane polishing unit of the at least two membrane polishing units has an inlet positioned at the retentate side of the first membrane polishing unit, a retentate outlet, and a permeate outlet, and in which a second membrane polishing unit of the at least two membrane polishing units has an inlet positioned at the retentate side of the second membrane polishing unit, a retentate outlet, and a permeate outlet; and
wherein the permeate outlet of the at least one membrane dealcoholization unit is connected to the inlet of the first membrane polishing unit, the permeate outlet of the first membrane polishing unit is connected to the inlet of the second membrane polishing unit, and wherein the retentate outlet of the second membrane polishing unit is connected to the inlet of the first membrane polishing unit, and the permeate outlet of the second membrane polishing unit is connected to the water inlet of the at least one membrane dealcoholization unit.

2. A membrane dealcoholization and water reduction system according to claim 1, wherein at least one of the membrane polishing units comprises one or more polishing stages.

3. A membrane dealcoholization and water reduction system according to claim 2, wherein the first polishing unit comprises two or more polishing stages.

4. A membrane dealcoholization and water reduction system according to claim 2, wherein one or more of the first polishing unit or the second polishing unit comprises two polishing stages.

5. A membrane dealcoholization and water reduction system according to claim 1, wherein the at least two membrane polishing units are reverse osmosis units.

6. A membrane dealcoholization and water reduction system according to claim 1, wherein the at least two membrane polishing units have a semipermeable membrane configured to allow water to pass and wherein the at least two membrane polishing units are configured to allow for an operating pressure in the range of 15 to 80 bar, and wherein the at least two membrane polishing units comprise a temperature control for adjusting to a temperature of −5 to 15° C.

7. A membrane dealcoholization and water reduction system according to claim 1, wherein the membrane dealcoholization unit is a reverse osmosis unit having a semipermeable membrane configured to allow water and alcohol to pass, and wherein the membrane dealcoholization unit is configured to allow an operating pressure in the range of 10 to 55 bar, and wherein the membrane dealcoholization unit further comprise a temperature control for adjusting to a temperature at or below 25° C.

8. A membrane dealcoholization and water reduction system according to claim 7, wherein the permeate outlet of the second membrane polishing unit is connected to the water inlet of the membrane dealcoholization unit directly or via an intermediate buffer tank.

9. A polishing section for use in a membrane dealcoholization and water reduction process, said polishing section comprising at least two membrane polishing units, where a first membrane polishing unit of the at least two membrane polishing units has an inlet positioned at a retentate side of the first membrane polishing unit, a retentate outlet, and a permeate outlet, and where a second membrane polishing unit of the at least two membrane polishing units has an inlet positioned at a retentate side of the second membrane polishing unit, a retentate outlet, and a permeate outlet;
wherein the inlet of the first membrane polishing unit is configured to be connected to a permeate outlet of a membrane dealcoholization unit, and
wherein the permeate outlet of the first membrane polishing unit is connected to the inlet of the second membrane polishing unit, and wherein the retentate outlet of the second membrane polishing unit is connected to the inlet of the first membrane polishing unit, and the permeate outlet of the second membrane polishing unit is configured to be connected to a water inlet of a membrane dealcoholization unit, and wherein one or both of the first and second polishing units comprise one or more polishing stages.

10. A method for reducing water consumption in a membrane dealcoholization process, said method comprising:
feeding a solution, such as a beverage product, comprising alcohol to a membrane dealcoholization unit to provide an alcohol reduced solution and an alcohol containing permeate;
feeding the alcohol containing permeate to a retentate side of a first membrane polishing unit to provide an alcohol enriched retentate and an alcohol depleted permeate;
feeding the alcohol depleted permeate to a retentate side of a second membrane polishing unit, to provide a second alcohol enriched retentate and a permeate substantially comprising or essentially consisting of water;
wherein the second alcohol enriched retentate or a fraction of the second alcohol enriched retentate is fed to the retentate side of the first membrane polishing unit, pre-mixed with the alcohol enriched permeate, or is discharged; and the permeate substantially comprising or essentially consisting of water is fed to a retentate side of the membrane dealcoholization unit, pre-mixed with a supply of external water.

11. A method for reducing water consumption in a membrane dealcoholization process according to claim 10, wherein the first membrane polishing unit comprises one or more polishing stages and wherein an alcohol enriched retentate from a polishing stage is fed to a retentate side of a subsequent polishing stage to provide a subsequent stage alcohol enriched retentate and a plurality of stages of permeates constitute the alcohol depleted permeate.

12. A method for reducing water consumption in a membrane dealcoholization process according to claim 11, wherein the first membrane polishing unit comprises 2 to 3 polishing stages.

13. A method for reducing water consumption in a membrane dealcoholization process according to claim 10, wherein the second membrane polishing unit comprises one or more polishing stages, and wherein a permeate from a polishing stage is fed to the retentate side of a subsequent polishing stage to provide a subsequent stage alcohol enriched retentate and a plurality of subsequent stages of permeates constitute the permeate substantially comprising or essentially consisting of water.

14. A method for reducing water consumption in a membrane dealcoholization process according to claim 13, wherein the second membrane polishing unit comprises 2 to 3 polishing stages.

15. A method for reducing water consumption in a membrane dealcoholization process according to claim 10, one or more of the first membrane polishing unit and/or second membrane polishing unit comprise 2 to 3 polishing stages.

16. A method for reducing water consumption in a membrane dealcoholization process according to claim 10, wherein the membrane dealcoholization unit and the first membrane polishing unit and the second membrane polishing unit are a reverse osmosis unit.

17. A method for reducing water consumption in a membrane dealcoholization process according to any claim 10, wherein the permeate substantially comprising or essentially consisting of water is fed to a buffer tank and wherein the permeate substantially comprising or essentially consisting of water is fed from the buffer tank to the retentate side of the membrane dealcoholization unit.

18. A method for reducing water consumption in a membrane dealcoholization process according to claim 17, wherein the solution, such as a beverage product, comprising alcohol, is subjected to a preconcentration, and wherein generated preconcentration water is fed to the buffer tank, through the at least two polishing units.

19. A method for reducing water consumption in a membrane dealcoholization process according to claim 10, wherein the beverage product is fed at a temperature at or below 25° C., and wherein the alcohol enriched permeate is cooled to a temperature in the range of −5 to 15° C. to provide a cooled alcohol enriched permeate which is fed to the first membrane polishing unit.

20. A method for reducing water consumption in a membrane dealcoholization process according to claim 10, wherein the alcohol reduced solution is recovered and sold, and wherein the alcohol enriched retentate is used as is, as alcohol base in an alcoholized solution, or is discharged.

21. A method for reducing water consumption in a membrane dealcoholization process according to claim 10, wherein the solution is a beverage, and wherein the alcohol content of the dealcoholized beverage is <0.5% abv.

22. A method for reducing water consumption in a membrane dealcoholization process according to claim 11, wherein the second alcohol enriched retentate or a fraction of the second alcohol enriched retentate is fed to the retentate side of the first membrane polishing unit, or when the retentate side of any of the polishing stages of the first or second membrane polishing units during operation, the second alcohol enriched retentate or a fraction of the second alcohol enriched retentate is pre-mixed with the alcohol enriched permeate, or the second alcohol enriched retentate or a fraction of the second alcohol enriched retentate is discharged from the method and used for other purposes during start-up or at the end of an operation of the method.

23. A method according to claim 10, wherein a mode of operation is batch.

24. A method and system according to claim 10, wherein an operation is batch mode and wherein the permeate substantially comprising or essentially consisting of water is fed to a top section of a buffer tank and the permeate substantially comprising or essentially consisting of water which is fed to the membrane dealcoholization unit is taken from a lower section of the buffer tank and further wherein the buffer tank is configured to allow the feed to layer such that there is minimal mixing whereby the holding time in the tank is substantially the same for any portion of the feed throughout the batch process.

25. A dealcoholization and water reduction system, said system comprising a membrane dealcoholization section and a polishing section in which the dealcoholization section comprises at least one membrane dealcoholization unit having a retentate side and a permeate side, said membrane dealcoholization unit having a feed inlet positioned at the retentate side of the membrane dealcoholization unit, a retentate outlet, a permeate outlet and a water inlet positioned at the retentate side of the membrane dealcoholization unit;
wherein the polishing section comprises at least one membrane polishing unit having a retentate side and a permeate side, in which the at least one membrane polishing unit has an inlet positioned at the retentate side of the at least one membrane polishing unit, a retentate outlet and a permeate outlet,
wherein the permeate outlet of the membrane dealcoholization unit is connected to the inlet of the at least one membrane polishing unit the permeate outlet of the at least one membrane polishing unit is connected to the water inlet of the membrane dealcoholization unit through an intermediate buffer tank.

26. A dealcoholization and water reduction system according to claim 25, wherein the at least one membrane polishing unit comprises one or more polishing stages.
